(19) United States
(12) Patent Application Publication
(10) Pub. No.: US 2011/0302394 A1
(43) Pub. Date: Dec. 8, 2011

(54) SYSTEM AND METHOD FOR PROCESSING REGULAR EXPRESSIONS USING SIMD AND PARALLEL STREAMS

(75) Inventors: GREGORY F. RUSSELL, Yorktown Heights, NY (US); Valentina Salapura, Chappaqua, NY (US); Daniele P. Scarpazza, Dobbs Ferry, NY (US)

(73) Assignee: INTERNATIONAL BUSINESS MACHINES CORPORATION, Armonk, NY (US)

(21) Appl. No.: 12/795,874

(22) Filed: Jun. 8, 2010

(51) Int. Cl. G06F 9/302

(52) U.S. Cl. 712/222; 712/E09.017

(57) ABSTRACT

A system and method for performing regular expression computations includes loading a plurality of input values corresponding to one or more input streams as elements of a vector register implemented on programmable storage media. New state indexes are computed using the input values, and current state values corresponding to different automata by using single instruction, multiple data (SIMD) vector operations. New state values associated with the different automata are determined using the new state indexes to look up new state values such that state transitions for a plurality of regular expressions are processed concurrently.

### GOVERNMENT RIGHTS

This invention was made with Government support under Contract No.: H98230-07-C-0409 awarded by the National Security Agency. The Government has certain rights in this invention.

### BACKGROUND

1. Technical Field

The present invention relates to regular expression computations and more particularly to a system and method for computing regular expressions using single instruction, multiple data (SIMD) vectors and parallel streams.

2. Description of the Related Art

Unstructured data stored in computer systems and environments is growing exponentially. A significant portion of processing for unstructured data includes regular expressions (e.g., regex or regX). A regular expression is a special text string for describing a search pattern and provides a concise and flexible means for matching strings of text, such as particular characters, words, or patterns of characters. A regular expression is written in a formal language that can be interpreted by a regular expression processor, a program that either serves as a parser generator or examines text and identifies parts that match the provided specification.

Processing of regular expressions is currently performed with sequential software algorithms or with state machines implemented in hardware. Sequential software solutions are typically slow, and hardware solutions are expensive and inflexible.

### SUMMARY

A system and method for performing regular expression computations includes loading a plurality of input values corresponding to one or more input streams as elements of a vector register implemented on programmable storage media. New state indexes are computed using the input values, and current state values corresponding to different automata by using single instruction, multiple data (SIMD) vector operations. New state values associated with the different automata are determined using the new state indexes to look up new state values such that state transitions for a plurality of regular expressions are processed concurrently.

Another method for performing regular expression computations includes loading a plurality of input data from a plurality of input streams for concurrent processing in a single instruction, multiple data (SIMD) structure for vector operations; adding the input data in a vector register to current state values in a general purpose register to generate new addresses for the input data; locating new automata states for each corresponding input stream in a transition table using the new addresses; and loading the new automata states as the current state values for a next iteration.

The new addressees may be determined by adding an index from the vector register and a state base address from a general purpose register, wherein data transfer between the vector register into the general purpose register is performed using a direct data transfer instruction. The new automata states may be determined using at least one of a common state transition table; distinct state transition tables to implement different behaviors, and multiple copies of a common state transition table to permit it more efficient parallel access to the state transition tables. The new automata states may be loaded directly into a state value vector register using addresses from a state index vector register by employing a vector gather operation.

A system for performing regular expression computations includes an input module configured to receive a plurality of input values from a plurality of input streams. A single instruction, multiple data (SIMD) vector unit configured to compute new state indexes using the input values, and current state values corresponding to different automata. A state transition table is stored in memory media to load new state values associated with the different automata using the new state indexes such that state transitions for a plurality of regular expressions are processed concurrently.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for fast and flexible computation of regular expressions in accordance with one embodiment;

FIG. 2 is a block/flow diagram showing one implementation including a vector unit for fast and flexible computation of regular expressions in four input streams in accordance with another embodiment;

FIG. 3 is a schematic diagram showing transactions between a vector register and a general purpose register in accordance with one embodiment;

FIG. 4 is a block diagram describing the implementation of a direct data transfer instruction in accordance with the present principles;

FIG. 5 is a flow diagram showing a method for computation of regular expressions in accordance with another embodiment;

FIG. 6 is a diagram illustrating behavior of an alternate direct data transfer instruction, in which words in a vector register are distributed among sequential general purpose registers in a single operation in accordance with one embodiment; and

FIG. 7 is a diagram illustrating behavior of a vector gather instruction in accordance with one embodiment.

### DETAILED DESCRIPTION OF PREFERRED EMBODIMENTS

The present principles provide a parallel system and method for processing regular expressions (RegX). In one embodiment, automata for processing RegX are advantageously implemented in software, and a single instruction, multiple data (SIMD) vector unit is employed. SIMD is a class of parallel computers with multiple processing elements that perform the same operation on multiple data simultaneously. Thus, these machines exploit data level parallelism. Several automata are worked on in parallel by packing values of several automata in one element of a SIMD vector. The SIMD unit processes several data streams in parallel, fetching data from different streams, and evaluating different automata for each data stream in parallel. The SIMD instructions provide efficient processing for data transfer between vector registers and general purpose registers.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

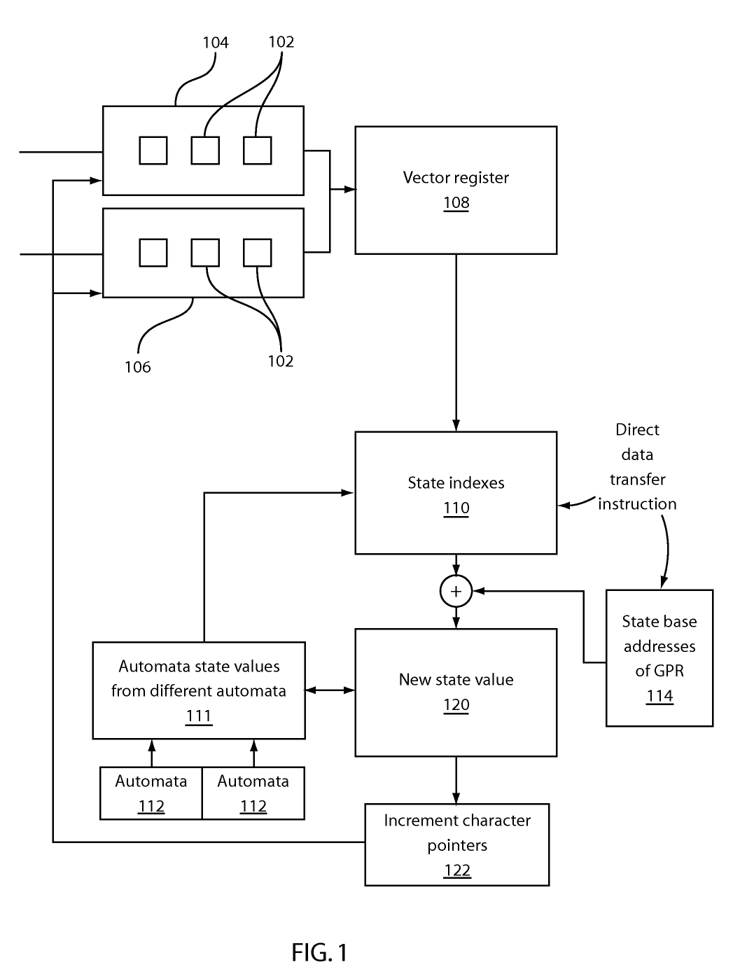

Referring now to the drawings in which like numerals represent the same or similar elements and initially to FIG. 1, a block/flow diagram shows a system for implementing regular expression computation of multiple streams in parallel in accordance with one illustrative embodiment. A plurality of different input values 102 corresponding to different input streams 104, 106 are loaded as elements into a single vector register 108. The input streams 104 and 106 may include a plurality of input streams and may be adjusted based upon a given computational architecture.

Based on current states of different automata 112, where each automata corresponds to processing of a single stream, and the input values in the vector register 108, state indexes of block 110 are computed using SIMD vector operations. The state indexes of block 110 are computed by employing the input values 102, and state values 111 corresponding to different automata 112.

Automata 112 (e.g., a finite state machine, look-up table, formula, or other state changing mechanism) for processing regular expressions are preferably implemented in software. Several automata 112 are worked on in parallel by packing values of several automata in one element of a SIMD vector. The SIMD structure processes several data streams in parallel, fetching data from different streams, and evaluating different automata for each data stream in parallel. The present principles use SIMD to maintain and execute multiple separate automata on multiple independent input streams.

Using the new state indexes of block 110, different new state values of block 120 are loaded. To load the new state values of block 120, general purpose registers (GPRs) 114 are employed. GPRs 114 hold state base addresses, and are used to calculate the new addresses. The new state indexes of block 110 are transferred from vector registers in block 110 into GPRs 114, and based on the state base addresses in GPRs of block 114 and the new state index values of block 110, an address of the new states is calculated in block 120. This computation usually includes adding a base address (114) to an index (in block 110). Based on the calculated address, the new state values of block 120 from the memory of the automata 112 are computed. The newly loaded state values ob block 120 are now current state values 111 of different automata for a next iteration. In block 122, character pointers are incremented for a next iteration.

An instruction to transfer data between different register types (e.g., vector in block 110 and GPR registers 114) is provided in accordance with the present principles. Using multiple data streams in parallel and SIMD vector architecture, regular expressions may be computed in parallel. This results in enormous time and cost savings. The parallel computation method exploits the data transfer instruction to provide performance improvements.

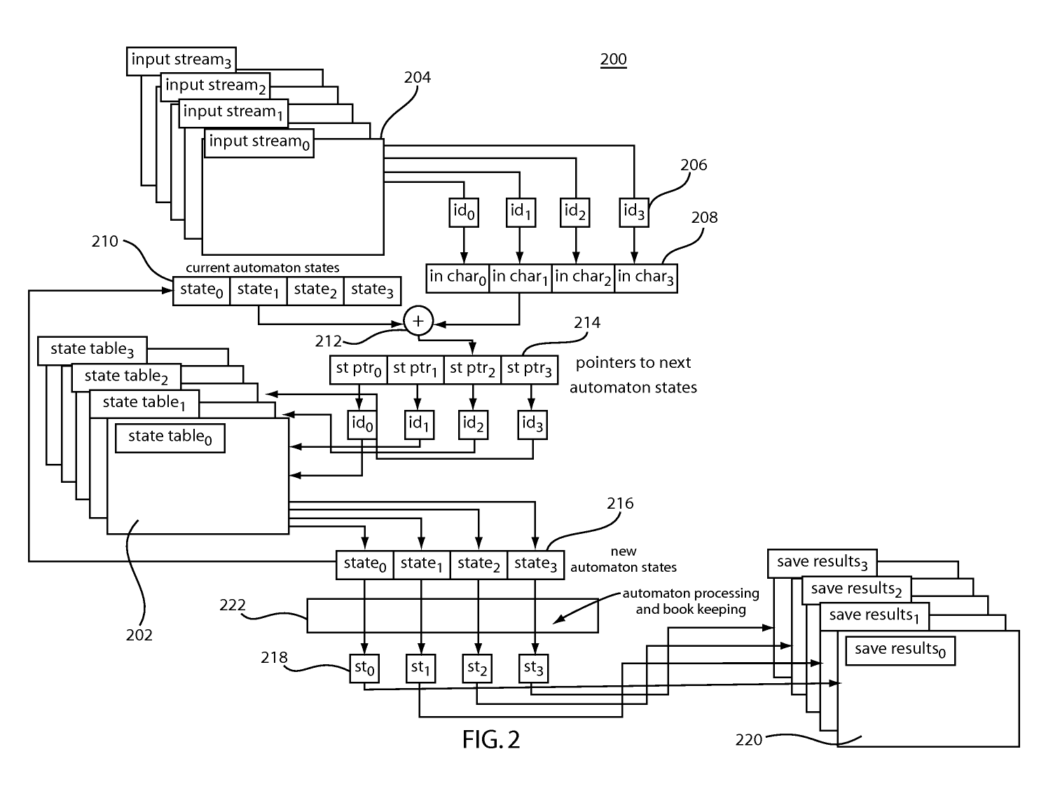

Referring to FIG. 2, a block/schematic diagram shows a vector unit 200 for implementing regular expression computations in parallel (SIMD) in accordance with another illustrative embodiment. Automata are constructed based on a set of regular expressions to be processed. Automata transition states are based upon conditions, and the automata may be employed in processing the input streams described herein. State transition tables or state tables 202 are constructed for transitioning states. The state tables 202 are indexed so that new states can be determined when a new index refers to the table 202. In the embodiment depicted in FIG. 2, four automata operate in parallel to provide state transitions for each iteration, one transition on each of four streams 204, e.g., on four segments of an input dataset 204. The input data set 204 may include portions of a single stream, four separate streams or combinations thereof. Parallel operation is provided in four lanes of the SIMD architecture of FIG. 2. It should be understood that any other number of elements are possible depending on SIMD unit width and element size.

The vector unit 200 operates on four separate input streams 204. For each stream, input characters (in charᵢ) are loaded using a load operation 206. The current automaton states 210 (e.g., state₀, state₁, state₂, state₃) and corresponding current input characters 208 (in char₀, in char₁, in char₂, in char₃) are added by an adder 212 for each of the streams 204 to compute state pointers (st ptr) 214. The addresses 214 are pointers to next states in the state tables 202 for each automata. The new states values are loaded to a register 216 for each stream. The different automata may employ a common state transition table or different automata may use distinct state transition tables to implement different behaviors or the different automata may employ multiple copies of a common state transition table to permit more efficient parallel access to the state transition tables. In one example, the addresses of the new state values are determined by adding the vector register including the new state indexes to a second vector register including base addresses of one or more state transition tables.

Check operations are implemented to track and control a number of iterations in the vector unit 200. In block 222, automaton processing and bookkeeping are implemented: determination of what information needs to be stored is made and data is stored. In one embodiment, the output of constant bit masks or other values are employed along with logic operations to set or determine which information needs to be stored. Bit masks may include, e.g., a final state bit, a back-up bit, a save bit, a token-type field, a state pointer mask, clear flags, etc. In this way, selected information is stored by a store operation 218 in save results memory 220. The output states are associated with one or more indexes and may be enqueued into token tables in memory 220. SIMD operators may include an AND operation (in block 222), ADD operations (212), etc.

The newly loaded state values 216 are now current state values 210 of different automata for a next iteration. In block 222, character pointers are incremented for a next iteration. New automata states (216) become current states (210).

Performance improvements are gained by concurrently computing regular expressions and similar structures using parallel processing. The parallel processing can be implemented using vectors. The vectors are manipulated using SIMD technology. It should be understood that the SIMD operations may include any number, type and/or combinations of operations. SIMD vector instructions may include integer arithmetic, logical operations, load/store instructions, etc. The SIMD operations may be implemented using hardware circuits or virtual (software) circuits.

Regular expression processing is accelerated using the SIMD vector unit 200. Finite State Machines (FSMs) make up a majority of matching engines which perform a transition for each symbol of the input stream. However, regex matching is an inherently sequential task, and the code that these tools generate is difficult to parallelize, especially in such a way as to expose data-level parallelism and exploit SIMD instructions, which are employed in accordance with the present principles.

One iteration of a FSM may use the current input character and its current state to compute its next state. It then produces the corresponding output, updates its current state, and advances the input. In the present embodiments, the input character (in charᵢ) is loaded from the input stream 204, while the next state is loaded from a transition table 202. Output data is stored to an output stream or memory 220. Traditional code may be employed to perform these tasks with variables stored in scalar registers and manipulated by scalar operations.

While a scalar instruction processes single operands at a time, a SIMD unit instruction processes multiple operands at a time, when they are organized in vector registers. Therefore, an organization, in accordance with the present embodiments, multiple FSM run at the same time by virtue of SIMD instructions. The FSMs operate on distinct input streams 204, produce distinct output and have their individual state variables (within automata), but they might share the same state-transition table or tables 202. In this organization, multiple instances of FSM variables (e.g., the current states 210) are kept in one vector register, and a single block of shared instructions (SIMD whenever possible) performs the above tasks for all the FSMs at the same time (e.g., adder 212).

The reorganization of scalar FSM code into SIMD code involves a substantial redesign, because the now-conjoined FSMs need to share the same control flow. To fuse the code of multiple FSMs into a single, branchless, SIMD-enabled block of code, a combination of predicated instructions, selection instructions and speculative writing are needed.

Speculative writing is a technique where, instead of using a branch to select code that either generates output or not depending on a condition, the programmer employs branchless code that selects a destination pointer on the basis of a condition, and then stores to that pointer. When the condition is false, the store deliberately writes data into a discarded location. Provided that enough independent streams are available for parallel processing, there is no limit to the SIMD width from which this approach can benefit: the wider, the better. The performance achieved, though, depends on multiple factors, such as, the fraction of scalar instructions that have a SIMD version, the need and cost of moving data from general purpose to vector registers, cache effects, and various others.

A difficulty in efficient processing of regex comes from their data-dependent memory access patterns. Unlike other applications, where the same calculation is performed independently on a large amount of data which are arranged in arrays, a regex processing application changes its flow depending on the current input. In an FSM, the current values of state and input are used to compute memory addresses for operations in a transition table. Text processing applications do not use separate groups of registers to hold data value, data addresses, and control flow information. Instead, data values are used for address calculation and control flow definition. This problem exhibits a similar memory access pattern as a pointer chasing kernel, and it is similarly difficult to optimize.

In parallel FSM-based methods, the address of the next state of the FSM is computed from the current value of elements in a vector register. The values in the vector register are frequently used as offsets from a base address. To calculate the next address, values have to be copied from the vector registers (block 110, FIG. 1) to general purpose registers (GPRs) (114, FIG. 1). In RISC architectures, such direct transfers between registers are not supported and require explicit load/store instructions. In recent processors, these transfers would require several instructions needing additional cycles to execute. For the present embodiments, the support for moving data efficiently from vector registers to GPRs is very beneficial.

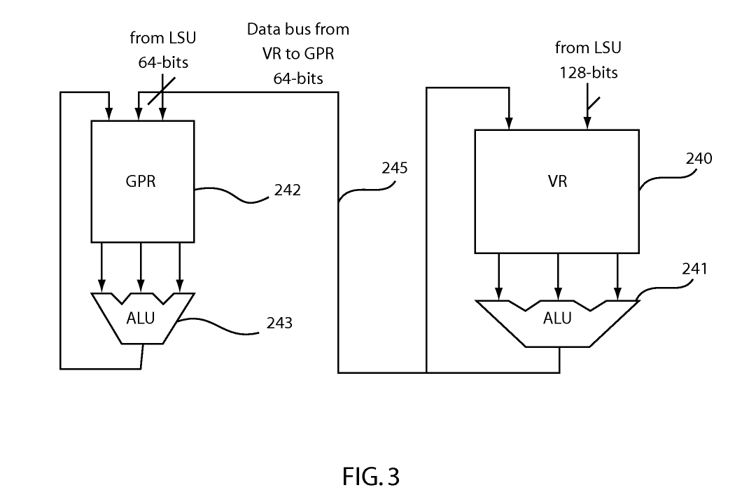

Referring to FIG. 3, vector registers (VR) 240 are used for saving data, and general purpose registers (GPR) 242 for address computations. Data is transferred from one set of registers to the other using SIMD operations. Data transfer between register types is implemented as storing data using a store or load operation from one set of registers to the other. In this embodiment, data transfer between VRs 240 to GPRs 242 is employed; however, different registers may be used and are also contemplated.

A data bus 245 between the VR 240 and the GPR 242 is illustratively depicted for 64 bits. It should be understood that other architectures may be employed and the bus 245 may be for 16 bits, 32 bits, 128-bits, 256 bits, etc. Arithmetic logic units (ALU) 241 and 243 are employed to carry out operations of the stored information in registers. In one embodiment, ALU 241 and 243 is/are programmed using an extract instruction to permit a stream-lined transformation between VR 241 and GPR 242. Data may be sent from load-store units (LSUs). In one embodiment, the general purpose register 242 has inputs from the load store unit (LSU), from its ALU unit 243 to write back results, and from the vector registers VR 240 for data transfer. Other inputs from other units are also possible. In another embodiment, data are stored in vector registers 240, and calculations on the data are performed in the ALU 241. Base addresses are stored in the general purpose registers 242, and address calculation is performed in the ALU 243.

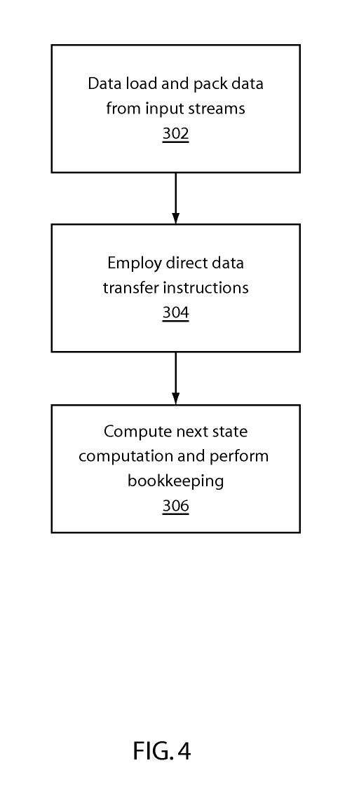

Referring to FIG. 4, a flow diagram shows an illustrative flow which employs SIMD instructions for performing integer arithmetic, logical operations and load store operations for implementing one embodiment. In block 302, data loading and packing is provided from a plurality of data streams. Instructions such as store vector (stv), load vector register (lvx), load general purpose register (lwz), vperm, etc. with associated address parameters may be employed.

In block 304, new instructions may be added to speed up data transfer between register types. An extract command (extract) may be added to the SIMD instruction set to direct data transfer from VRs to GPRs in a more efficient manner. The extract command is a direct data transfer instruction that handles the transfer between register types, e.g., vector to general purpose. In one embodiment, the extract instruction transfers 64 bits of vector register into a GPR register. In another embodiment, the extract instruction transfers 32 bits of vector register into a GPR register. In yet another embodiment predetermined fixed consecutive bits of the vector registers are transferred to a GPR register. The position of consecutive bits from the vector register which are to be transferred to a GPR register is preferably programmable. The direct data transfer instruction preferably employs optimized hardware capabilities for low cost data transfer. In block 306, next state computation and bookkeeping are provided. Instructions such as vector AND (vand), vsubuwm, vcmpgtuw, vsraw and others with associated address parameters may be employed.

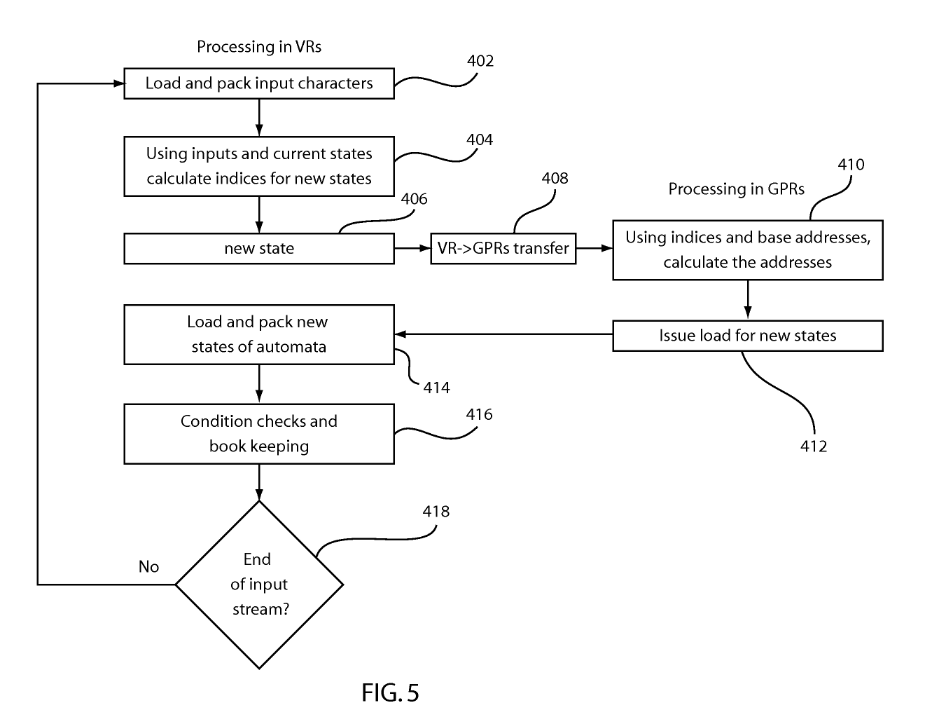

Referring to FIG. 5, a block/flow diagram describes SIMD vector unit operations in greater detail. In block 402, the vector unit fetches/loads inputs from a plurality of streams (e.g., four streams as depicted in FIG. 2). The inputs are loaded or packed into vector registers (VRs). In block 404, using the inputs and current states, indices for new states are computed. In block 406, a new state is determined and stored in vector registers. In block 408, a transfer is made from the vector registers to general purpose registers (GPRs). As described above, the GPRs include base information while the VRs include indexes for updating the base information. In block 410, using the indices and the base addresses, new addresses are computed. In block 412, a load instruction is issued to obtain new states based on the newly determined addresses.

In block 414, new states from the automata are loaded and packed using the new state addresses. The new automata states are determined for a next iteration of stream processing for each individual stream input. In block 416, condition checks and book keeping are performed. Condition checks include comparisons such as, e.g., determining whether a result meets a threshold, an end of buffer is reached, etc. Book keeping includes tasks such as generating tokens, storing data in tables, maintaining associated pointers, storing needed values, etc. This may include information needed for a next iteration, information responsive/relevant to a query, etc. In block 418, a determination is made as to whether an end of an input stream has been reached. If it has been reached the process ends. Otherwise, the process returns to block 402.

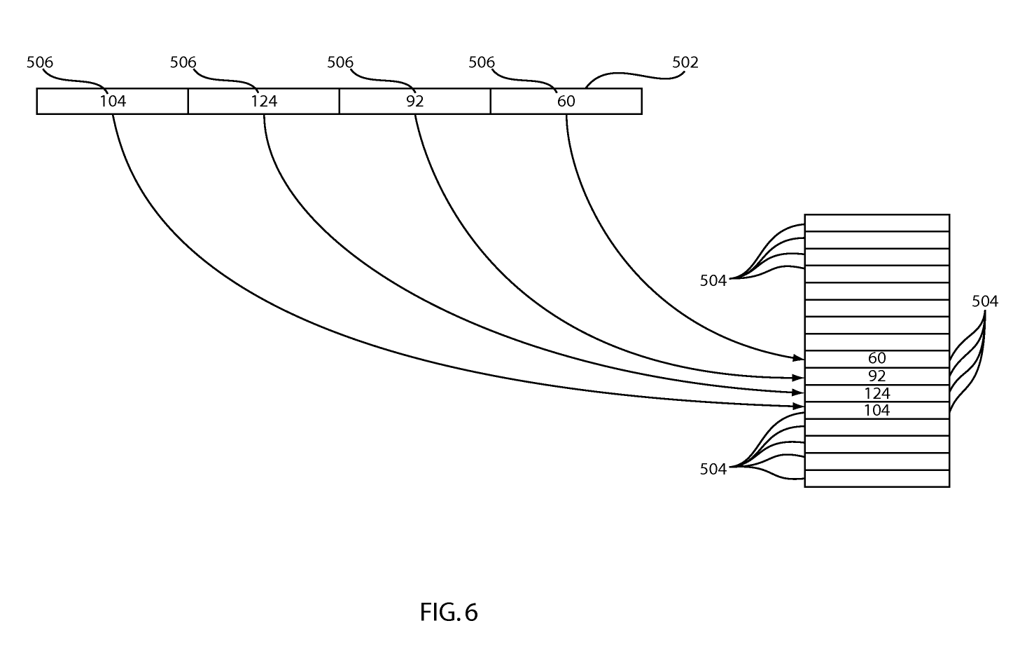

Referring to FIG. 6, a diagram illustrates the behavior of a direct data transfer instruction (e.g., an extract instruction), in which words 506 contained in a vector register 502 are distributed among sequential GPR registers 504 in a single operation. A corresponding direct data transfer instruction performs a reverse operation, gathering values from a plurality of general purpose registers 504 into a single vector register 502.

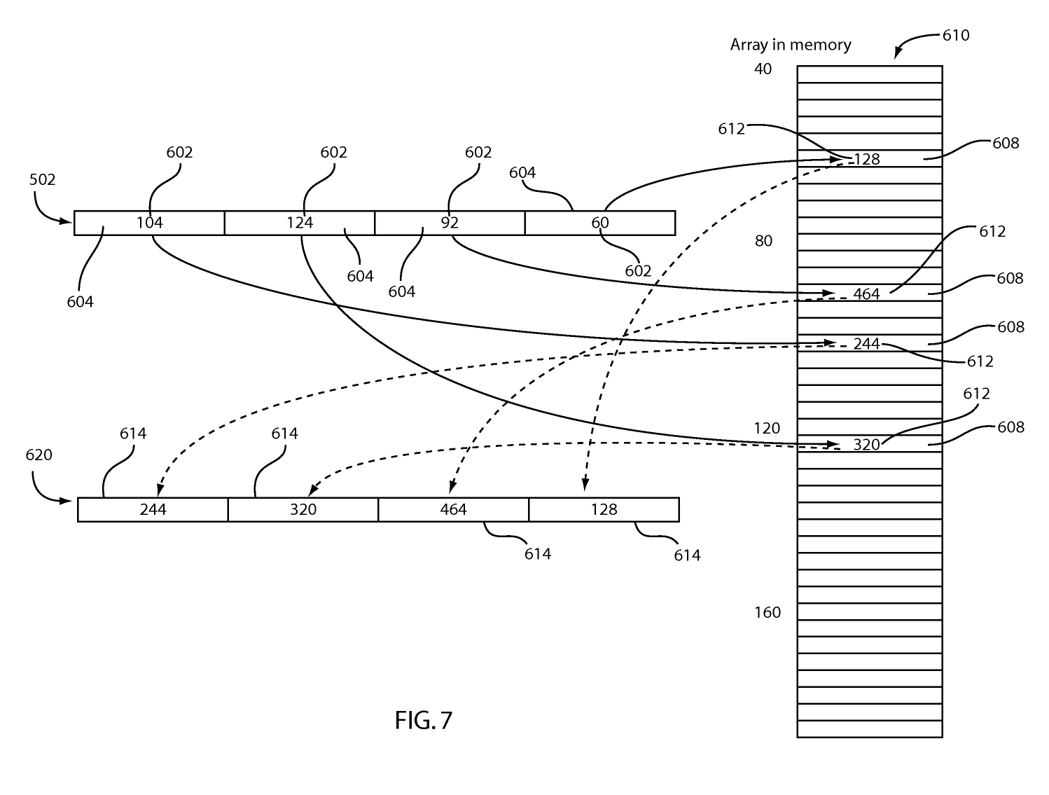

Referring to FIG. 7 is a diagram which illustrates the behavior of a vector gather instruction. This diagram illustratively shows four indexes 602 in four words 604 of a vector register 502, used as pointers to four distinct addresses 608 in a memory array 610. Word values 612 from the four memory locations are “gathered” together into a second vector register 620, each word 614 in the new vector 620 corresponds to the address in the same word of the original vector register 520. In one embodiment, new state values are loaded directly into a state value vector register using addresses from a state index vector register using the vector gather operation.

Having described preferred embodiments of a system and method for efficient computation of regular expressions using SIMD and parallel streams (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for performing regular expression computations, comprising:
loading a plurality of input values corresponding to one or more input streams as elements of a vector register implemented on programmable storage media;
computing new state indexes using the input values, and current state values corresponding to different automata by using single instruction, multiple data (SIMD) vector operations; and
determining new state values associated with the different automata using the new state indexes to look up new state values such that state transitions for a plurality of regular expressions are processed concurrently.

2. The method as recited in claim 1, wherein the new state indexes are determined by adding an index from the vector register and a state base address from a general purpose register.

3. The method as recited in claim 2, wherein data transfer between the vector register into the general purpose register is performed using a direct data transfer instruction.

4. The method as recited in claim 3, wherein the direct data transfer instruction employs hardware to reduce cost for data transfer.

5. The method as recited in claim 1, wherein the different automata employ a common state transition table.

6. The method as recited in claim 1, wherein the different automata employ distinct state transition tables to implement different behaviors.

7. The method as recited in claim 1, wherein the different automata employ multiple copies of a common state transition table to permit more efficient parallel access to the multiple copies of the common state transition table.

8. The method as recited in claim 1, wherein computing new state indexes includes computing the new state indexes which correspond directly to addresses of the new state values in a state transition table.

9. The method as recited in claim 8, further comprising loading the new state values directly into a state value vector register using addresses from a state index vector register using a vector gather operation.

10. The method as recited in claim 1, wherein determining new state values includes determining new state values such that addresses of the new state values are determined by adding the vector register including the new state indexes to a second vector register including base addresses of one or more state transition tables.

11. A computer readable storage medium comprising a computer readable program for performing regular expression computations, wherein the computer readable program when executed on a computer causes the computer to perform the steps of:
loading a plurality of input values corresponding to one or more input streams as elements of a vector register implemented on programmable storage media;
computing new state indexes using the input values, and current state values corresponding to different automata by using single instruction, multiple data (SIMD) vector operations; and
determining new state values associated with the different automata using the new state indexes to look up new state values such that state transitions for a plurality of regular expressions are processed concurrently.

12. The computer readable storage medium as recited in claim 11, wherein the new state indexes are determined by adding an index from the vector register and a state base address from a general purpose register.

13. The computer readable storage medium as recited in claim 12, wherein data transfer between the vector register into the general purpose register is performed using a direct data transfer instruction.

14. The computer readable storage medium as recited in claim 11, wherein the different automata employ at least one of a common state transition table; distinct state transition tables to implement different behaviors, and multiple copies of a common state transition table to permit more efficient parallel access to the multiple copies of the common state transition table.

15. The computer readable storage medium as recited in claim 11, wherein computing new state indexes includes computing the new state indexes which correspond directly to addresses of the new state values in a state transition table.

16. The computer readable storage medium as recited in claim 15, further comprising loading the new state values directly into a state value vector register using addresses from a state index vector register using a vector gather operation.

17. The computer readable storage medium as recited in claim 11, wherein determining new state values includes determining new state values such that addresses of the new state values are determined by adding the vector register including the new state indexes to a second vector register including base addresses of one or more state transition tables.

18. A method for performing regular expression computations, comprising:
loading a plurality of input data from a plurality of input streams for concurrent processing in a single instruction, multiple data (SIMD) structure for vector operations;
adding the input data in a vector register implement in memory storage media to current state values in a general purpose register to generate new addresses for the input data;
locating new automata states for each corresponding input stream in a transition table using the new addresses; and
loading the new automata states as the current state values for a next iteration.

19. The method as recited in claim 18, wherein the new addressees are determined by adding an index from the vector register and a state base address from a general purpose register, wherein data transfer between the vector register into the general purpose register is performed using a direct data transfer instruction.

20. The method as recited in claim 18, wherein the new automata states are determined using at least one of a common state transition table; distinct state transition tables to implement different behaviors, and multiple copies of a common state transition table to permit more efficient parallel access to the multiple copies of the common state transition table.

21. The method as recited in claim 18, wherein loading the new automata states includes loading the new automata states directly into a state value vector register using addresses from a state index vector register with a vector gather operation.

22. A system for performing regular expression computations, comprising:
an input module configured to receive a plurality of input values from a plurality of input streams;
a single instruction, multiple data (SIMD) vector unit configured to compute new state indexes using the input values, and current state values corresponding to different automata; and
a state transition table stored in memory storage media to load new state values associated with the different automata using the new state indexes such that state transitions for a plurality of regular expressions are processed concurrently.

23. The system as recited in claim 22, wherein the new state indexes are determined by combining input values in a vector register with state base addresses stored in a general purpose register, wherein data transfer between the vector register into the general purpose register is performed using a direct data transfer instruction.

24. The system as recited in claim 22, wherein the new automata states are determined using at least one of a common state transition table; distinct state transition tables to implement different behaviors, and multiple copies of a common state transition table to permit more efficient parallel access to the multiple copies of the common state transition table.

25. The system as recited in claim 22, wherein the new state values associated with the different automata are collected directly into a state value vector register using addresses from a state index vector register using a vector gather operation.
